(19) United States
(12) Patent Application Publication
(10) Pub. No.: US 2016/0180888 A1
(43) Pub. Date: Jun. 23, 2016

(54) Annotating Media Content With User-Specified Information

(71) Applicant: Intel Corporation, Santa Clara, CA (US)

(72) Inventors: Christopher J. Cormack, Hillsboro, OR (US); Tony Moy, Beaverton, OR (US)

(21) Appl. No.: 15/055,372

(22) Filed: Feb. 26, 2016

Related U.S. Application Data
(63) Continuation of application No. 13/653,657, filed on Oct. 17, 2012.
Application No. 13/653,657 is a continuation of application No. 10/700,910, filed on Nov. 3, 2003, now abandoned.

(51) Int. Cl. G11B 27/036; H04N 21/4223; H04N 21/431; H04N 21/422; H04N 5/45; H04N 5/272

(52) U.S. Cl. CPC G11B 27/036; H04N 5/45; H04N 5/272; H04N 21/4316; H04N 21/42203; H04N 21/4223

(57) ABSTRACT

A method of annotating stored media information may include outputting stored media information based on an associated index file and receiving an annotation request at a point in the index file. The method may also include receiving and storing annotation information associated with the annotation request. The index file may be modified at the point at which the annotation request was received to reference the stored annotation information.

### CROSS-REFERENCE TO RELATED APPLICATIONS

This is a continuation of U.S. non-provisional application Ser. No. 10/700,910 filed Nov. 3, 2003, hereby expressly incorporated by reference herein.

### BACKGROUND

The claimed invention relates to media devices and, more particularly, to information handling by media devices.

### BRIEF DESCRIPTION OF THE DRAWINGS

Some embodiments are described with respect to the following figures:

FIG. 1 illustrates an example system consistent with the principles of the invention;

FIG. 2 is a flow chart illustrating a process of annotating media information according to an implementation consistent with the principles of the invention; and

FIG. 3 is a flow chart illustrating a process of displaying annotated media information according to an implementation consistent with the principles of the invention.

### DETAILED DESCRIPTION

The following detailed description refers to the accompanying drawings. The same reference numbers may be used in different drawings to identify the same or similar elements. Also, the following detailed description illustrates certain implementations and principles, but the scope of the claimed invention is defined by the appended claims and equivalents.

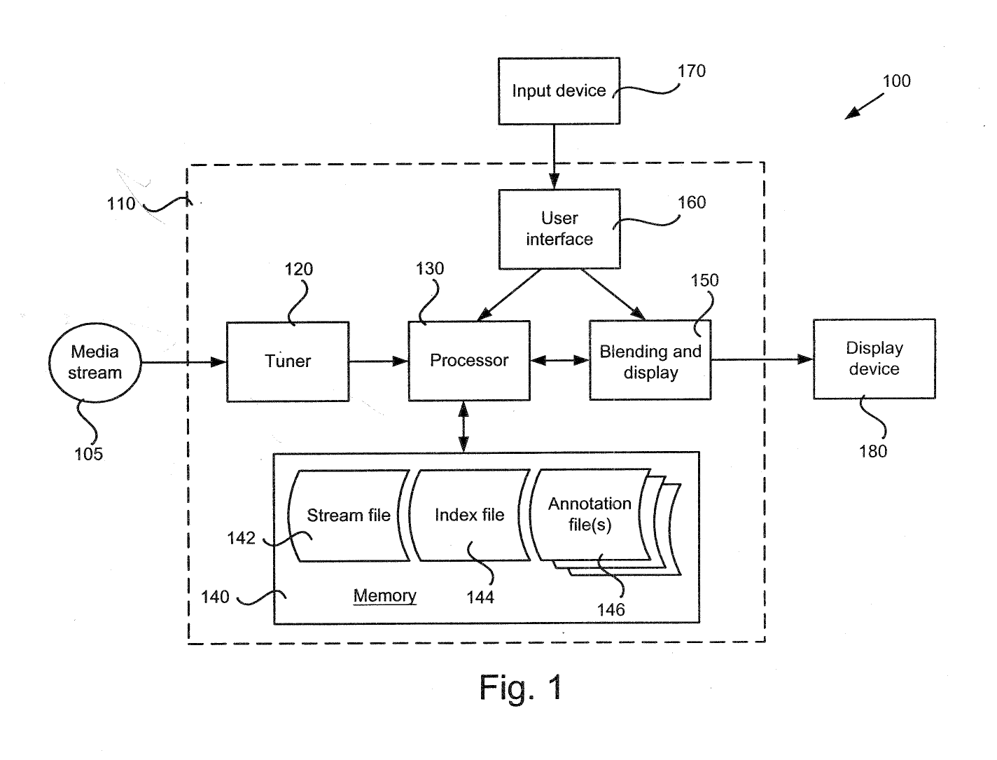

FIG. 1 illustrates an example system 100 consistent with the principles of the invention. System 100 may include a media stream 105, a media device 110, an input device 170, and a display device 180. Media stream 105, input device 170, and display device 180 may all be arranged to interface with media device 110.

Media stream 105 may arrive from a source of media information via a wireless or wired communication link to media device 110. Media stream 105 may include one or more individual streams (e.g., channels) of media information. Sources of media streams 105 may include cable, satellite, or broadcast television providers. Media stream 105 may also originate from a device, such as a video camera, playback device, a video game console, a remote device across a network (e.g., the Internet), or any other source of media information.

Media device 110 may receive media information from media stream 105 and may output the same or different media information to display device 180 under the influence of input device 170. Some examples of media devices 110 may include personal video recorders (PVRs), media centers, set-top boxes, and/or general-purpose or special-purpose computing devices.

FIG. 1 also illustrates an example implementation of media device 110 in system 100 consistent with the principles of the invention. Media device 110 may include a tuner 120, a processor 130, a memory 140, a blending and display module 150, and a user interface 160. Although media device 110 may include some or all of elements 120-160, it may also include other elements that are not illustrated for clarity of explanation. Further, elements 120-160 may be implemented by hardware, software/firmware, or some combination thereof, and although illustrated as separate functional modules for ease of explanation, elements 120-160 may not be implemented as discrete elements within media device 110.

Tuner 120 may include one or more devices arranged to separate media stream 105 into one or more streams of information. Although it is contemplated that multiple tuners may be present, for clarity of explanation tuner 120 will be described as a single tuner. Tuner 120 may lock onto and output one stream of information, such as a television channel or other information, present at a certain frequency range in media stream 105.

Although illustrated in media device 110, in some implementations tuner 120 may be located external to media device 110 to provide one input stream (e.g., channel) to media device 110. In some implementations, tuner 120 may not be present at all, for example, if a playback device such as a video camera or recorder is providing only one stream of information in media stream 105.

Processor 130 may interact with memory 140 to process a stream of information from tuner 120. Processor 130 may also interact with blending and display module 150 and user interface 160 to display media information from memory 140 and/or tuner 120. Further details of processor 130's interoperation with these other elements of media device 110 will be subsequently provided. Processor 130 may primarily control writing of information to memory 140 and reading of information from memory 140. In addition, processor 130 may also perform other associated tasks, such as encoding or decoding of media information before and/or after storage in memory 140. For example, processor 130 may convert media information to or from various formats, such as MPEG-1, MPEG-2, MPEG-4 (from the Moving Picture Experts Group), or any other known or later-developed format. Processor 130 may also control which input stream of information is selected by tuner 120.

Processor 130 may operate in at least two modes: a recording mode and a playback mode. In the recording mode, processor 130 may store media information to memory 140, with or without encoding it first. Optionally, processor 130 may pass the media information through to blending and display module 150 for concurrent output to display device 180. In the playback mode, processor 130 may read media information from memory 140 for display on display device 180.

Memory 140 may include a stream file 142, an index file 144, and annotation files 146. Memory 140 may include a solid-state, magnetic or optical storage medium, examples of which may include semiconductor-based memory, hard disks, optical disks, etc. Though memory 140 is only illustrated as connected to processor 130 in FIG. 1, in practice memory 140 may be connected to one or both of tuner 120 and/or blending and display module 150 to facilitate recording or playback of media information.

Although stream file 142 and index file 144 may be referred to in the singular for ease of description herein, these files may each include multiple files or other subdivisions of the stream and index information therein. Similarly, although annotation files 146 may be referred to in the plural for ease of description herein, annotation information may in practice be stored in a single file or other data structure.

Stream file 142 may include media information from tuner 120 that is stored by processor 130 in the recording mode. Stream file 142 may be implemented as a fixed-size buffer or circular file that loops back to its beginning when its end is reached to reduce the possibility of filling up memory 140 with media information. Stream file 142 may include a time-continuous stream of media information or several discontinuous streams. In playback mode, processor 130 may read media information from any portion of stream file 142 to play desired media.

Index file 144 may be generated by processor 130 when writing media information to stream file 142, and it may include index information to permit playback of desired portions of the media information in stream file 142. Index file 144 may also include frame information to support additional playback functions, such as fast-forwarding or rewinding. In addition, index file 144 may also be modified by processor 130, either at the time of its creation or at a later time, to refer to annotation files 146, as will be further described below.

Annotation files 146 may include pieces of annotation information, or links to annotation information, that are associated with the media information in stream file 142. Typically, the annotation information in annotation files 146 may be associated with a particular time in a certain portion of the media information in stream file 142, and thus may also be referenced by the part of index file 144 that refers to that particular time in the certain portion of the media information in stream file 142. The annotation information in annotation files 146 may include any renderable media information, such as text, graphics, pictures, audio information, video information, and the like. The annotation information may also include metadata (e.g., data about data) or control information. For example, the annotation information may include instructions that tell processor 130 and/or display device 180 to play back a scene in the media information slowly, or to pause the scene.

Annotation files 146 also may include links to the annotation information instead of the annotation information itself. Although some latency may be introduced by the process of retrieving the linked annotation information, links to such information may suffice if the latency is within acceptable bounds. In such a linked scenario, processor 130 may retrieve the linked annotation information via a connected network link (not shown).

Blending and display module 150 may be arranged to blend the video data from processor 130 with any other display information, such as menus, graphical overlays, time/date, or other similar information before output to display device 180. For example, blending and display module 150 may respond to a request from user interface 160 to display desired information, such as the channel, time, or an interactive menu, by overlaying such information on the video information from processor 130. Blending and display module 150 may also combine different streams of information to accomplish various display functions, such as picture-in-picture or alpha blending, and perform buffering, if necessary.

User interface module 160 may translate commands and other information from input device 170 to processor 130 and/or blending and display module 150. User interface module 160 may include one or more communication interfaces, such as an infrared or other wireless interface, to communicate with input device 170. If appropriate, user interface 160 may abstract commands from input device to a more general format, for example translating an “up channel” button push to a tuner command to increase a channel.

User interface module 160 may direct inputs to processor 130 and/or blending and display module 150 based on the functions of the inputs. If inputs from input device 170 are intended for tuner 120 or involve access to memory 140, user interface module 160 may direct them to processor 130. If inputs from input device 170 are intended to alter the display of information on display device 180, user interface module 160 may direct them to blending and display module 150. User interface module 160 may direct certain inputs to both processor 130 and blending and display module 150 if such inputs serve multiple functions, such as a fast-forward command which may alter streaming from processor 130 and produce overlaid visual feedback (e.g., 2.times. or 4.times. fast-forward rate) in blending and display module 150.

Input device 170 may include a controller and one or more data generators (not shown), and it may communicate with user interface module 160 via a wireless or wired communication link. The controller in input device 170 may include a remote control arranged to control playback of video data via processor 130 and to control display of the video data via blending and display module 150. The controller may also be used to designate annotation information already present in memory 140 of media device 110. For example, the controller may select from a listing of annotation information in annotation files 146.

The one or more data generators in input device 170 may include a keyboard, a key pad, a graphical input device, a microphone, a camera, and/or any suitable apparatus for generating annotation information such as text, graphical data, audio, pictures, video, and so forth. Once generated, such annotation information may be sent to annotation files 146 via user interface 160 and processor 130. Although input device 170 is shown separate from media device 110, in some implementations consistent with the principles of the invention, one or more data generators may be present in media device 110. In some implementations, for example, media device 110 may include a microphone and/or outward-facing camera for collecting audio and/or video annotation information from a user of input device 170.

Display device 180 may include a television, monitor, projector, or other device suitable for displaying media information, such as video and audio. Display device 180 may utilize a number of technologies for such displaying, including cathode ray tube (CRT), liquid crystal display (LCD), plasma, and/or projection-type technologies. In some implementations, display device 180 may be located proximate media device 110, which may in some implementations sit on top of or adjacent to the display. In other implementations consistent with the principles of the invention, display device 180 may be located remote from media device 110.

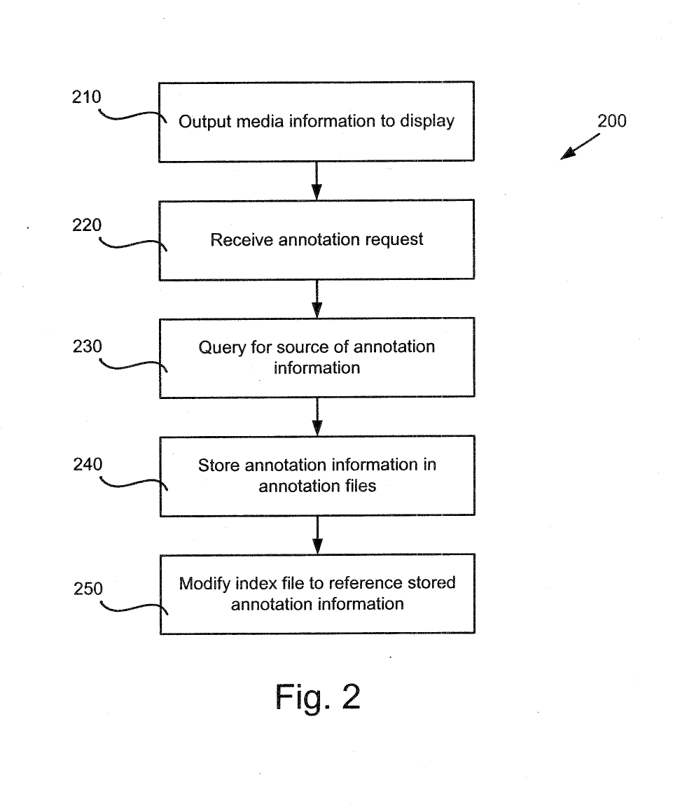

FIG. 2 is a flow chart illustrating a process 200 of annotating media information according to an implementation consistent with the principles of the invention. Processing may begin with processor 130 outputting media information to display device 180 via blending and display module 150 [act 210]. Processor 130 may output the media information either from tuner 120 or from stream file 142 in memory 140. If processor outputs the media information from tuner 120, it may concurrently record the media information to stream file 142 and write corresponding index information to index file 144.

At some point, processor 130 may receive an annotation request from input device 170 via user interface 160 [act 220]. In response to the request, processor 130 may, in some implementations, temporarily pause or slow down the outputting of media information until annotation begins. In some implementations, processor 130 may insert a placeholder into index file 144 at the point that the annotation request arrived.

Optionally, processor 130 may query the user for a source of the annotation information, for example, by a menu of choices inserted into the media information by blending and display module 150 [act 230]. In response to the query, a user may specify the source of the annotation information, such as a keyboard, microphone, graphical input device, or a local or remote file. Also in response to the query, a user may set other parameters associated with the impending annotation, such as whether to continue playback of the media information during annotation, and if so, at what speed.

In some implementations consistent with the principles of the invention, optional act 230 may be omitted, such as when the annotation request in act 220 specifies the source of the annotation information. For example, a user may press a “voice annotate” button on input device 170 which would indicate that audio annotation information is forthcoming. In some implementations, input device 170 may be configured so that any annotation activity, such as speaking near a microphone or writing on a graphical tablet, may supply the request in act 220 as well as the source of the annotation information.

Processor 130 may store received annotation information to annotation files 146 in memory 140 [act 240]. If the annotation information is received from input device 170, processor 130 may store it in annotation files 146, with or without compressing or encoding it prior to storage. If the annotation information is in a local or remote file, processor 130 may retrieve the file and store it in annotation files 146, or processor 130 may just store a link to the local or remote file in annotation files 146. In addition to storing the annotation information, in some implementations processor 130 may concurrently display this annotation information by sending it to blending and display module 150. In such implementations, the user may experience the effect of the media information plus the annotation information when the annotation information is added.

Processor 130 may modify index file 144 in memory 140 to refer to the stored annotation information in annotation files 146 [act 250]. Index file 144 may be modified to indicate that annotation information exists at a certain time relative to media information in stream file 142, and to point to that annotation information within annotation files 146. In this manner, the location of annotation information in annotation files 146 and its timing relative to the media information in stream file 142 may be stored in index file 144 by media device 110.

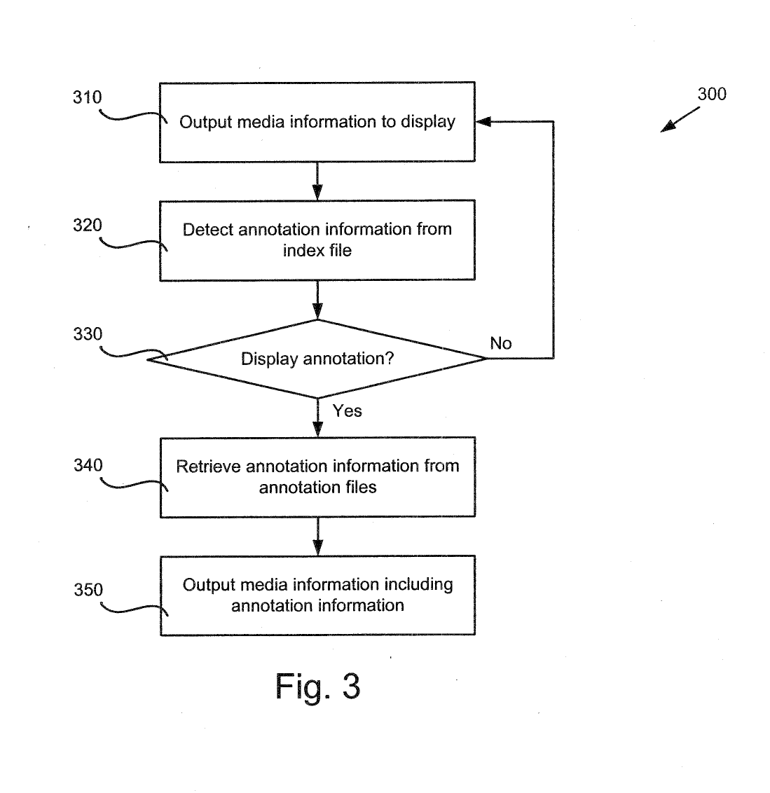

FIG. 3 is a flow chart illustrating a process 300 of displaying annotated media information according to an implementation consistent with the principles of the invention. Processing may begin with processor 130 outputting stored media information from stream file 142 in memory 140 to display device 180 via blending and display module 150 [act 310]. As previously mentioned, processor 130 may use index file 144 in conjunction with playback of the media information in stream file 142.

At some point during playback of the stored media information, processor 130 may detect the presence of annotation information from index file 144 [act 320]. Optionally, processor 130 may query the user whether the detected annotation information should be displayed [act 330]. Such a query may take the form of an overlaid graphic added to the media information by blending and display module 150. In addition to the query, processor 130 may, in some implementations, temporarily pause the media information until the user answers the query. If the user declines to view the annotation information, processor 130 may resume outputting the unannotated media information as in act 310.

If the user decides to experience the annotation information in response to act 320, or if act 320 is omitted because of a preference to always display annotation information when present, processor 130 may retrieve the annotation information from annotation files 146 in memory 140 [act 340]. If the annotation information is wholly present in memory 140, processor 130 may perform a read of the portion of annotation files 146 specified by the index file 144 where the annotation information was detected. If the annotation file 146 includes a link (e.g., a hyperlink or other address) to remotely stored annotation information, however, processor 130 may retrieve the remote annotation information in act 340 via a communication link (not shown).

Processing may continue with processor 130 sending both media information from stream file 142 and the annotation information to blending and display module 150 to be combined and output to display device 180 [act 350]. If the annotation information includes text, graphical information, or video, for example, such may be presented by blending and display module 150 separately from the media information (e.g., picture in picture) or together with the media information (e.g., alpha blending). If the annotation information includes audio information, for example, it may be mixed with an audio stream in the media information by blending and display module 150. In this manner, previously annotated media information may be displayed by media device 110.

The annotation information may be displayed concurrently with the normally playing media information. In some implementations, however, the annotation information may be displayed while the media information is temporarily paused or slowed down. Such a technique may be used to highlight an upcoming event or a transient event in the media information. It is specifically contemplated that, consistent with the principles of the invention, media information and annotation information may be presented relative to each other using different techniques than the ones explicitly described herein.

The foregoing description of one or more implementations consistent with the principles of the invention provides illustration and description, but is not intended to be exhaustive or to limit the claimed invention to the precise form disclosed. Modifications and variations are possible in light of the above teachings or may be acquired from practice of the invention.

For example, although the user-added information has been described herein as “annotation” information, such added information may be added for any purpose, and not solely to make notes on or comment on (i.e., annotate) the media information to which it is added. Also, although FIG. 3 describes displaying annotation information in the course of playback of media information from stream file 142, the annotations to index file 144 may also be used for non-linear playback from stream file 142. For example, annotation information may be used to organize or designate certain portions of the media information in stream file 142 for an annotated “highlight reel,” for reordering to create a different playback order of the media information, or for any other editorial purpose.

Moreover, the acts in FIGS. 2 and 3 need not be implemented in the order shown; nor do all of the acts necessarily need to be performed. Also, those acts that are not dependent on other acts may be performed in parallel with the other acts. Further, the acts in these figures may be implemented as instructions, or groups of instructions, implemented in a machine-readable medium.

No element, act, or instruction used in the description of the present application should be construed as critical or essential to the invention unless explicitly described as such. Also, as used herein, the article “a” is intended to include one or more items. Where only one item is intended, the term “one” or similar language is used. Variations and modifications may be made to the above-described implementation(s) of the claimed invention without departing substantially from the spirit and principles of the invention. All such modifications and variations are intended to be included herein within the scope of this disclosure and protected by the following claims.

The graphics processing techniques described herein may be implemented in various hardware architectures. For example, graphics functionality may be integrated within a chipset. Alternatively, a discrete graphics processor may be used. As still another embodiment, the graphics functions may be implemented by a general purpose processor, including a multicore processor.

References throughout this specification to “one embodiment” or “an embodiment” mean that a particular feature, structure, or characteristic described in connection with the embodiment is included in at least one implementation encompassed within the present invention. Thus, appearances of the phrase “one embodiment” or “in an embodiment” are not necessarily referring to the same embodiment. Furthermore, the particular features, structures, or characteristics may be instituted in other suitable forms other than the particular embodiment illustrated and all such forms may be encompassed within the claims of the present application.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1-15. (canceled)

16. A computing device capable of wirelessly receiving, when the computing device is in operation, media data from a remote media data source, the computing device comprising:
a wireless communication interface capable of wirelessly receiving, when the computing device is in the operation, user-specified information to be provided, at least in part, via a keyboard;
a microphone and outwardly facing camera capable of being used to obtain, at least in part, when the computing device is in the operation, media information;
at least one processor, comprising hardware, capable of executing software that when executed results in the computing device being capable, at least in part, of combining, at least in part, the media information and the media data to produce, at least in part, output data that is capable of being provided, via the computing device, to a remote display device for playing at the remote display device, the output data being capable of comprising video information and audio information;
the output data also being capable of being based, at least in part, upon graphical user input and/or the user-specified information;
the graphical user input and/or user-specified information being capable of being associated, at least in part, with at least one effect that is to be associated with the output data when played at the remote display device, the at least one effect being capable of comprising:
video overlay effect; and/or
picture-in-picture effect.

17. The computing device of claim 16, wherein:
the at least one effect is also capable of comprising alpha blending.

18. The computing device of claim 16, wherein:
the video overlay effect comprises graphical information overlay.

19. The computing device of claim 16, wherein:
the at least one effect is also capable of comprising adjustment in rate of the playing.

20. The computing device of claim 16, wherein:
the computing device comprises solid state memory to store, at least in part, the media data.

21. The computing device of claim 16, wherein:
the computing device also comprises firmware; and
the at least one processor comprises at least one multicore processor capable of executing instructions associated, at least in part, with the combining.

22. The computing device of claim 16, wherein:
the graphical user input and/or user-specified information are also capable of being associated, at least in part, with editing associated, at least in part, with production, at least in part, of the output data.

23. The computing device of claim 16, wherein:
when the computing device is in the operation, the computing device is capable of wirelessly receiving the media data from the remote media data source via the Internet.

24. The computing device of claim 16, wherein:
the graphical user input comprises graphical user tablet input.

25. Non-transitory computer readable memory storing instructions that are capable of being executed by at least one processor of a computing device, the at least one processor comprising hardware, the instructions when executed by the at least one processor resulting in the computing device being capable of performing operations comprising:
wirelessly receiving, by the computing device, media data from a remote media data source;
wirelessly receiving, via a wireless communication interface of the computing device, user-specified information to be provided, at least in part, via a keyboard;
obtaining, at least in part, via use of a microphone and outwardly facing camera of the computing device, media information;
combining, at least in part, the media information and the media data to produce, at least in part, output data that is capable of being provided, via the computing device, to a remote display device for playing at the remote display device, the output data being capable of comprising video information and audio information;
the output data also being capable of being based, at least in part, upon graphical user input and/or the user-specified information;
the graphical user input and/or user-specified information being capable of being associated, at least in part, with at least one effect that is to be associated with the output data when played at the remote display device, the at least one effect being capable of comprising:
video overlay effect; and/or
picture-in-picture effect.

26. The non-transitory computer readable memory of claim 25, wherein:
the at least one effect is also capable of comprising alpha blending.

27. The non-transitory computer readable memory of claim 25, wherein:
the video overlay effect comprises graphical information overlay.

28. The non-transitory computer readable memory of claim 25, wherein:
the at least one effect is also capable of comprising adjustment in rate of the playing.

29. The non-transitory computer readable memory of claim 25, wherein:
the computing device comprises solid state memory to store, at least in part, the media data.

30. The non-transitory computer readable memory of claim 25, wherein:
the computing device also comprises firmware; and
the at least one processor comprises at least one multicore processor.

31. The non-transitory computer readable memory of claim 25, wherein:
the graphical user input and/or user-specified information are also capable of being associated, at least in part, with editing associated, at least in part, with production, at least in part, of the output data.

32. The non-transitory computer readable memory of claim 25, wherein:
the wirelessly receiving the media data from the remote media data source is, at least in part, via the Internet.

33. The non-transitory computer readable memory of claim 25, wherein:
the graphical user input comprises graphical user tablet input.

34. A method implemented, at least in part, using a computing device, the method comprising:
wirelessly receiving, by the computing device, media data from a remote media data source;
wirelessly receiving, via a wireless communication interface of the computing device, user-specified information to be provided, at least in part, via a keyboard;
obtaining, at least in part, via use of a microphone and outwardly facing camera of the computing device, media information;
combining, at least in part, the media information and the media data to produce, at least in part, output data that is capable of being provided, via the computing device, to a remote display device for playing at the remote display device, the output data being capable of comprising video information and audio information;
the output data also being capable of being based, at least in part, upon graphical user input and/or the user-specified information;
the graphical user input and/or user-specified information being capable of being associated, at least in part, with at least one effect that is to be associated with the output data when played at the remote display device, the at least one effect being capable of comprising:
video overlay effect; and/or
picture-in-picture effect.

35. The method of claim 34, wherein:
the at least one effect is also capable of comprising alpha blending.

36. The method of claim 34, wherein:
the video overlay effect comprises graphical information overlay.

37. The method of claim 34, wherein:
the at least one effect is also capable of comprising adjustment in rate of the playing.

38. The method of claim 34, wherein:
the computing device comprises solid state memory to store, at least in part, the media data.

39. The method of claim 34, wherein:
the computing device also comprises firmware and at least one processor; and
the at least one processor comprises at least one multicore processor that is capable of executing instructions associated, at least in part, with the combining.

40. The method of claim 34, wherein:
the graphical user input and/or user-specified information are also capable of being associated, at least in part, with editing associated, at least in part, with production, at least in part, of the output data.

41. The method of claim 34, wherein:
the wirelessly receiving the media data from the remote media data source is, at least in part, via the Internet.

42. The method of claim 34, wherein:
the graphical user input comprises graphical user tablet input.
